(19) United States
(12) Patent Application Publication
(10) Pub. No.: US 2008/0010242 A1
(43) Pub. Date: Jan. 10, 2008

(54) Device authentication method using broadcast encryption (BE)

(75) Inventors: Weon-il Jin, Yongin-si (KR); Bae-eun Jung, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/651,596

(22) Filed: Jan. 10, 2007

(30) Foreign Application Priority Data
Jul. 5, 2006 (KR) 2006-62813

(51) Int. Cl. G06F 17/30

(52) U.S. Cl. 707/2

(57) ABSTRACT

A device authentication method using broadcast encryption is provided, in which, a hash value corresponding to a group key version is generated, the generated hash value is encrypted with a group key, group key information comprising the encrypted hash value is generated, and the generated group key information including a signature of an authentication server for the group key information is transmitted. Accordingly, mutual authentication is accomplished by using the group key version including in the group key information.

### CROSS-REFERENCE TO RELATED APPLICATIONS

This application claims the benefit under 35 U.S.C. § 119(a) of Korean Patent Application No. 2006-62813, filed Jul. 5, 2006, the entire disclosure of which is hereby incorporated by reference.

### BACKGROUND OF THE INVENTION

1. Field of the Invention

The present invention relates to device authentication using broadcast encryption (BE). More particularly, the present invention relates to a device authentication method of sharing a group key between devices to be authenticated using the BE and authenticating the devices using a secret key.

2. Description of the Related Art

Broadcast encryption (BE) is an efficient method for a transmitter (broadcast center) to send information only to intended users among all users. The BE needs to work effectively when a user aggregation to receive the information changes arbitrarily and dynamically. The most crucial property of the BE is to revoke or exclude unintended users, for example, illegal users or expired users.

For device authentication, a public key authentication, a secret key authentication, and the BE are generally adapted. The public key authentication authenticates the devices using public key certificates. In doing so, the public key authentication validates certificates using a public key operation. Disadvantageously, the public key operation is complicated.

In the secret key authentication, devices to authenticate execute mutual authentication by sharing their secret key.

However, when a certain device is hacked, the secret key authentication is unable to exclude the hacked device from the authenticating objects. Accordingly, there is a need for an improved device authentication method that revokes an unauthorized device using a shared group key between devices to be authenticated.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a device authentication method using broadcast encryption (BE), which carries out a mutual device authentication using a group key version contained in group key information.

Another aspect of exemplary embodiments of the present invention is to provide a device authentication method using BE, which verifies integrity of group key information using a group key version.

According to an aspect of exemplary embodiments of the present invention, an integrity verification method includes generating a hash value corresponding to a group key version; encrypting the generated hash value with a group key; and generating group key information comprising the encrypted hash value.

In an exemplary implementation, the hash value may be generated by generating a random number and substituting the generated random number into a hash function.

In another exemplary implementation, the hash value may be generated with a decreasing degree of the hash function as the group key version increases.

In still another exemplary implementation, N-ary hash values from 1 to n may be generated to correspond to n-ary group key versions from 1 to n.

In a further exemplary implementation, the group key information may comprise at least one of a group key version, an index, an encrypted group key, and an encrypted hash key.

In an exemplary implementation, the hash value corresponding to the group key version may be encrypted, and the encrypting may include transmitting the generated group key information comprising the group key version and the encrypted hash value corresponding to the group key version.

In another exemplary implementation, the group key information may comprise broadcast encryption (BE) group key information.

In still another exemplary implementation, the integrity verification method may further include transmitting the generated group key information comprising a signature of an authentication server for the group key information.

According to an aspect of exemplary embodiments of the present invention, an integrity verification method includes receiving group key information comprising an encrypted hash value; decrypting the encrypted hash value; comparing the decrypted hash value with pre-stored group key information comprising a hash value; and verifying integrity of the group key information according to the comparison result.

In an exemplary implementation, the group key information comprising a group key version and the encrypted hash value corresponding to the group key version may be received.

In another exemplary implementation, the hash value may be received by substituting a random number into a hash function.

In still another exemplary implementation, the group key information may comprise at least one of a group key version, an index, the encrypted group key, and the encrypted hash value.

In a further exemplary implementation, the decrypted hash value may be hashed several times, and the hash value may be compared with the hash value in the pre-stored group key information.

In an exemplary implementation, the integrity of the group key information may be verified by determining whether the group key information received in the receiving of the group key information comprises a latest version when the hash value equals to the pre-stored group key information comprising the hash value according to the result of the comparison.

In another exemplary implementation, the group key information may be BE group key information.

According to another aspect of exemplary embodiments of the present invention, an integrity verification method includes concatenating at least one group key and at least one group key version; encrypting a concatenated value; and generating group key information comprising the encrypted concatenated value.

In an exemplary implementation, the group key information may comprise at least one of a group key version, an index, and the encrypted concatenated value.

In another exemplary implementation, the group key information may be BE group key information.

In still another exemplary implementation, the integrity verification method may further include transmitting the group key information.

According to another aspect of exemplary embodiments of the present invention, an integrity verification method includes receiving group key information comprising at least one encrypted concatenated value; and verifying integrity of the group key information by decrypting the at least one encrypted concatenated value.

In an exemplary implementation, the group key information may comprise at least one of a group key version, an index, and the encrypted concatenated value.

In another exemplary implementation, the group key information may comprise BE group key information.

According to still another aspect of exemplary embodiments of the present invention, a device authentication method includes requesting group key version information; receiving the requested group key version information; comparing a pre-stored group key version with the received group key version and determining whether group key information comprise a latest version; and sharing the latest version of the group key information.

In an exemplary implementation, the determining of the group key information may include requesting the group key information when the received group key version is determined to have the latest version. The group key information of the latest version may be shared by receiving the group key information.

In another exemplary implementation, the group key information of the latest version may be shared by transmitting the group key information when the pre-stored group key version has the latest version according to the determination result.

In still another exemplary implementation, the group key information may be shared according to the BE.

In a further exemplary implementation, the device authentication method may further include calculating a group key based on the group key information; and mutually authenticating an object device to be authenticated using the calculated group key according to a secret key cryptography.

In an exemplary implementation, the requested group key information may be received from the object device to be authenticated, and the pre-stored group key version may be received from an authentication server.

In another exemplary implementation, the determining of the group key information may determine presence or absence of the pre-stored group key version, and when the pre-stored group key version is not received, the determining of the group key information may include requesting group key information comprising a group key version, to the authentication server; and receiving the group key information from the authentication server.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a flowchart outlining a device authentication method using broadcast encryption (BE) according to an exemplary embodiment of the present invention;

FIG. 2 is a diagram illustrating the device authentication method based on secret key authentication according to an exemplary embodiment of the present invention;

FIG. 3 is a flowchart outlining the device authentication using an authentication server according to an exemplary embodiment of the present invention;

FIG. 4 is a diagram showing exemplary group key information to which the integrity verification is applied according to an exemplary embodiment of the present invention;

FIG. 5 is a diagram showing another exemplary group key information to which the integrity verification is applied according to an exemplary embodiment of the present invention; and

FIG. 6 is a diagram showing yet another exemplary group key information to which the integrity verification is applied according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Hereinafter, certain exemplary embodiments of the present invention will be described in detail with reference to the accompanying drawing figures.

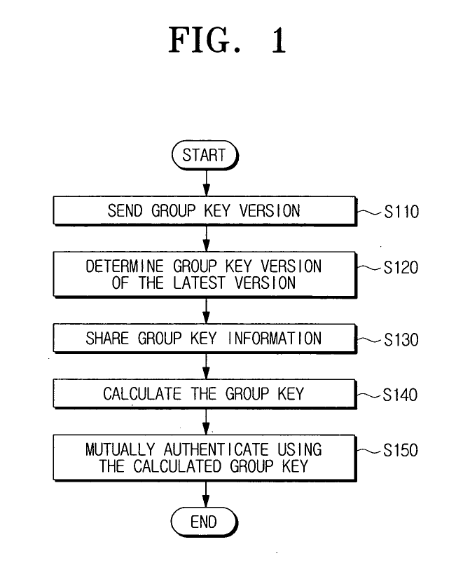

FIG. 1 is a flowchart outlining a device authentication method using broadcast encryption (BE) according to an exemplary embodiment of the present invention. For simplicity, descriptions are limited to a case where group key information is stored to both devices to mutually authenticate.

A device A and a device B transmit a version contained in their stored group key information (hereafter, referred to as a group key version) to each other for mutual authentication (S110). Herein, the group key version differs every time a revoked device and an authorized device change.

Next, the device A determines the latest version in the two group key versions by comparing its stored group key version information A with the group key version B received from the device B (S120). Likewise, the device B determines the latest version by comparing its group key version B with the group key version A received from the device A. The latest version is determined using date and time when the group key information is generated, index, and the like.

The devices A and B share the group key information of the latest version determined (S130).

Accordingly, when the group key version B is determined to have the latest version in step S120, the device A sends a group key information request message to the device B. Upon receiving the group key information request message, the device B sends its stored group key information B to the device A. Thus, the devices A and B share the group key information B of the latest version.

When the group key version A is determined to have the latest version, the devices A and B share the group key information A of the latest version in the same way.

Next, the device A and the device B calculate a group key using the sharing group key information (S140). The group key is calculated according to the broadcast encryption (BE). Since the BE is a well-known technique, its detailed explanation will be omitted for clarity and conciseness.

Based on the calculated group key, the devices A and B carry out mutual authentication (S150).

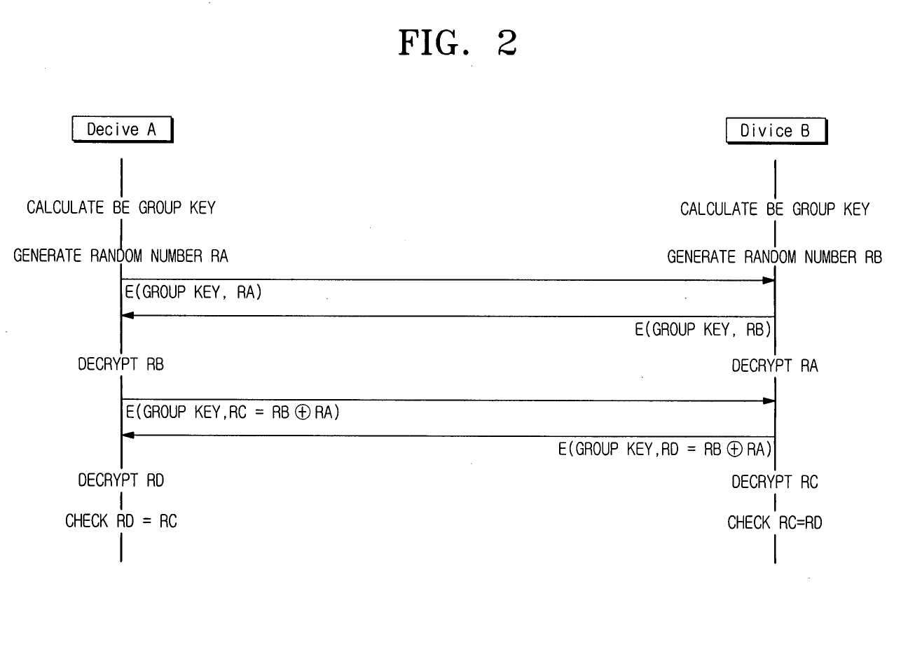

In more detail, referring now to FIG. 2, the device A generates a random number RA, encrypts the random number RA with the group key calculated in step S140, and then sends the encrypted RA (E(group key, RA)) to the device B.

The device B also generates a random number RB, encrypts the generated random number RB with the group key, and then sends the encrypted RB (E(group key, RB)) to the device A. The devices A and B decrypt the encrypted RB and RA, respectively, encrypt values RC=RB⊕RA and RD=RA⊕RB, which are acquired by applying the exclusive OR on the decrypted RB and RA and their generated random numbers RA and RB, with the group key, and then send E(group key, RC=RB⊕RA) and E(group key, RD=RA⊕RB) to each other. The device A executes the mutual authentication with the device B by decrypting the RD and verifying whether the decrypted RD is the same as its calculated RC. Likewise, the device B executes the mutual authentication with the device A by decrypting the RC and verifying whether the decrypted RC is the same as its calculated RD.

The device authentication method has been illustrated in case where the group key information is stored to both the device A and the device B. Note that the device authentication method is applicable to a case where the group key information is stored to either the device A or the device B.

Even if the group key information is stored to neither the device A nor the device B, the mutual authentication of the device A and the device B is feasible by receiving the group key information from authentication servers respectively connected to the device A and the device B. In this case, when the group key information is stored to either authentication server connected to the device A or the device B, the mutual device authentication of an exemplary embodiment of the present invention is feasible.

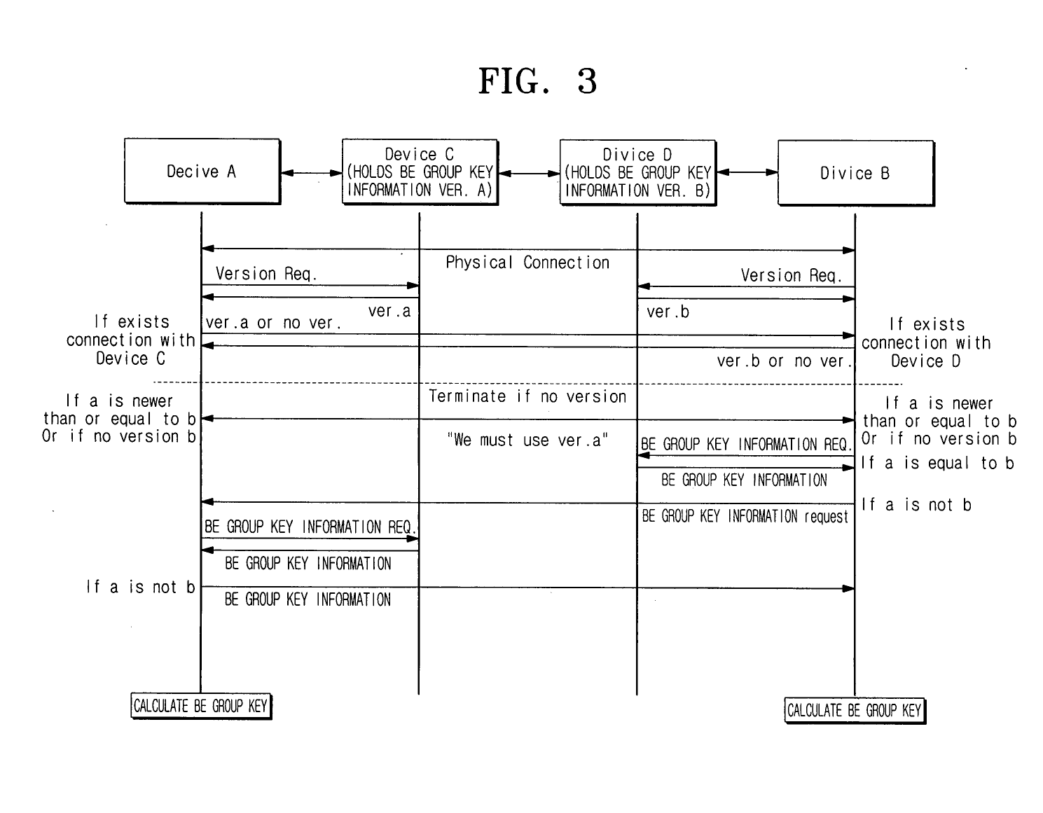

For example, referring to FIG. 3, a group key version request message Version Req. is transmitted from the device to the server and the group key version Ver.a/Ver.b is received from the server prior to step S110. Hence, the mutual device authentication in accordance with an exemplary embodiment of the present invention is feasible.

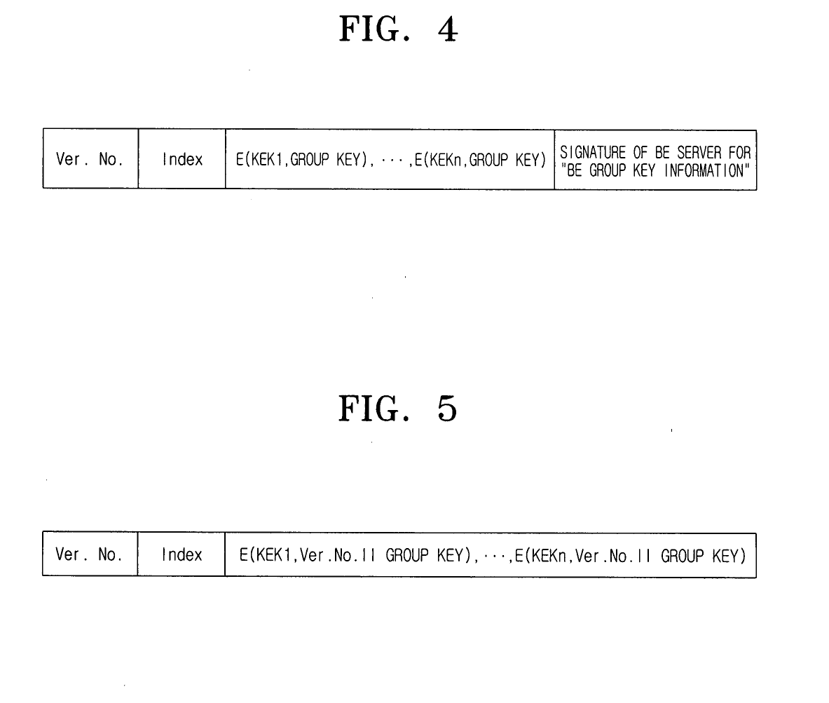

Descriptions have been provided above on how to share the group key based on the group key version contained in the group key information according to the BE and to mutually authenticate the devices using the secret key. The following descriptions illustrate the integrity verification of the group key version when the devices are mutually authenticated using the group key version in reference to FIGS. 4, 5, and 6.

FIGS. 4, 5, and 6 show examples of the group key information to which the integrity verification is applied according to an exemplary embodiment of the present invention. Herein, Ver. No. denotes the group key version, and Index indicates information used to determine which encrypted group key is used for the decryption.

FIG. 4 is a diagram showing exemplary group key information to which the integrity verification is applied according to an exemplary embodiment of the present invention. Referring to FIG. 4, the authentication server is able to generate group key information which contains group key version, index, the encrypted group key, and signature as to the group key information, and verify integrity of the group key version when the generated group key information is transmitted to the device.

Since the authentication server is capable of generating the signature to the group key information, the device receiving the group key information with the signature of the authentication server for the group key information can verify the integrity of the group key version.

FIG. 5 is a diagram showing another exemplary group key information to which the integrity verification is applied according to an exemplary embodiment of the present invention.

Referring to FIG. 5, after concatenating the group key version and the group key, the authentication server generates group key information by encrypting with a key encryption key (KEK) (E(KEKi, Ver. No.∥group key). That is, the authentication server generates the group key version, the index, and the concatenated group key to the group key information including the encrypted value.

The device, which receives the group key information as shown in FIG. 5, decrypts the encrypted value with the KEK (E(KEKi, Ver. No.∥group key) to thus verify the integrity of the group key version. Herein, the device verifies the integrity of the group key version by decrypting one of the values encrypted with the KEK.

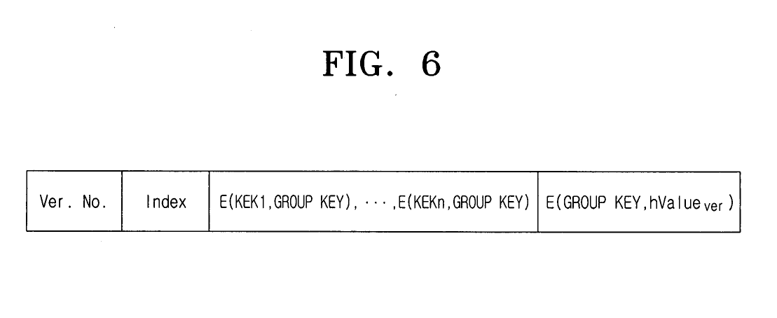

FIG. 6 is a diagram showing yet another exemplary group key information to which the integrity verification is applied according to an exemplary embodiment of the present invention.

Referring to FIG. 6, the authentication server generates hash values hValueᵥₑᵣ with respect to the group key versions, encrypts the hash values with the group key, and generates group key information. That is, the authentication server generates the group key information containing the encrypted hash values. Herein, the group key information contains the group key version, the index, the encrypted group key, and the encrypted hash values.

The authentication server generates a version and a hash value relating to the group key information every time the group key information is generated. For instance, when there are n-ary group key versions, hash values corresponding to the n-ary versions are generated respectively. The hash values are acquired by substituting an arbitrary random number ran into the hash function.

In doing so, the authentication server acquires the hash values by substituting the random number ran into the hash function to correspond to the increasing group key version. For instance, when the group key version is n−1, the authentication server sets the value h(ran) acquired by hashing the random number ran one time, to the hash value. When the group key version is n−2, the value h²(ran) acquired by hashing the random number two times is set to the hash value.

The one-way hash function transforms an input value of an arbitrary length to a fixed-length output value. The one-way hash function has the following properties. The one-way hash function is impossible to calculate an original input value with a given output value and is impossible to find another input value that produces the same output value with a given input value. In addition, the one-way hash function is impossible to find and calculate two different input values that result in the same output value.

The hash function characterized by the above features is one of important functions applied for data integrity, authentication, repudiation prevention, and the like. In an exemplary embodiment of the present invention, the one-way hash function can be a Secure Hash Algorithm version 1.0 (SHA-1).

Accordingly, to verify the integrity of the group key version using the group key information including the encrypted hash value, the device receiving the group key information from the device to be authenticated can compare the hash value of its stored group key information with the value which is hashed from the encrypted hash value in the group key information for several times, as shown in FIG. 6.

By way of example, the device B has a more recent version than the device A such that the group key version of the device B is 3 and the group key version of the device is 2. The device A compares the value hⁿ⁻²(ran) acquired by hashing the hash value hⁿ⁻³(ran) of the group key information received from the device B once (1=3−2), with the hash value hⁿ⁻²(ran) of its stored group key information, and confirms that the received group key information is of the latest version when the two values equal.

In the integrity verification method of the group version using the group key information containing the encrypted hash value in an exemplary embodiment of the present invention, when the group key version equals to a preset value, the authentication server resets and issues the group key version. Accordingly, the hash value corresponding to the group key version is re-issued.

In the authentication method and the integrity verification method according to an exemplary embodiment of the present invention, the group key information used to authenticate the device and verify the integrity of the group key version may comprise the BE group key information, but not limited to this group key version.

As set forth above, the authenticating devices carry out the mutual authentication by use of the group key version comprised in the group key information. Thus, the computations required for the authentication can be reduced and the exclusion of the revoked device from the object devices can be facilitated.

Furthermore, the secure data communications between privileged devices can be achieved by providing the integrity of the group key information using the group key version.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An integrity verification method comprising:
generating a hash value corresponding to a group key version;
encrypting the generated hash value with a group key; and
generating group key information comprising the encrypted hash value.

2. The integrity verification method as in claim 1, wherein the generating of the hash value comprises generating a random number and substituting the generated random number into a hash function.

3. The integrity verification method as in claim 3, wherein the generating of the hash value comprises generating with a decreasing degree of the hash function as the group key version increases.

4. The integrity verification method as in claim 1, further comprising generating n-ary hash values from 1 to n to correspond to n-ary group key versions from 1 to n.

5. The integrity verification method as in claim 1, wherein the group key information comprises at least one of a group key version, an index, an encrypted group key, and a encrypted hash key.

6. The integrity verification method as in claim 1, wherein the hash value corresponding to the group key version is encrypted, and the encrypting comprises transmitting the generated group key information comprising the group key version and the encrypted hash value corresponding to the group key version.

7. The integrity verification method as in claim 1, wherein the group key information comprises broadcast encryption (BE) group key information.

8. The integrity verification method as in claim 1, further comprising transmitting the generated group key information comprising a signature of an authentication server for the group key information.

9. An integrity verification method comprising:
receiving group key information comprising an encrypted hash value;
decrypting the encrypted hash value;
comparing the decrypted hash value with pre-stored group key information comprising a hash value; and
verifying integrity of the group key information according to the comparison result.

10. The integrity verification method as in claim 9, wherein the group key information comprising a group key version and the encrypted hash value corresponding to the group key version are received.

11. The integrity verification method as in claim 9, wherein the hash value is received by substituting a random number into a hash function.

12. The integrity verification method as in claim 9, wherein the group key information comprises at least one of a group key version, an index, the encrypted group key, and the encrypted hash value.

13. The integrity verification method as in claim 9, wherein the decrypted hash value is hashed a plurality of times, and the hash value is compared with the hash value in the pre-stored group key information.

14. The integrity verification method as in claim 13, wherein the integrity of the group key information is verified by determining whether the group key information received in the receiving of the group key information comprises a recent version when the hash value equals to the pre-stored group key information comprising the hash value according to the comparison result.

15. The integrity verification method as in claim 9, wherein the group key information comprises broadcast encryption (BE) group key information.

16. An integrity verification method comprising:
concatenating at least one group key and at least one group key version;
encrypting a concatenated value; and
generating group key information comprising the encrypted concatenated value.

17. The integrity verification method as in claim 16, wherein the group key information comprises at least one of a group key version, an index, and the encrypted concatenated value.

18. The integrity verification method as in claim 16, wherein the group key information comprises broadcast encryption (BE) group key information.

19. The integrity verification method as in claim 16, further comprising transmitting the group key information.

20. An integrity verification method comprising:
receiving group key information comprising at least one encrypted concatenated value; and
verifying integrity of the group key information by decrypting the at least one encrypted concatenated value.

21. The integrity verification method as in claim 20, wherein the group key information comprises at least one of a group key version, an index, and the encrypted concatenated value.

22. The integrity verification method as in claim 20, wherein the group key information comprises broadcast encryption (BE) group key information.

23. A device authentication method comprising:
requesting a version of group key information;
receiving the requested group key version information;
comparing a pre-stored group key version with the received group key version and determining whether the group key information comprises a recent version; and
sharing the recent version of the group key information.

24. The device authentication method as in claim 23, wherein the determining of the group key information comprises:
requesting the group key information when the received group key version comprises the recent version,
wherein the recent version of the group key version information is shared by receiving the group key information.

25. The device authentication method as in claim 23, wherein the recent version of the group key information is shared by transmitting the group key information when the pre-stored group key version comprises the latest version according to the determination result.

26. The device authentication method as in claim 23, wherein the group key information is shared according to broadcast encryption (BE).

27. The device authentication method as in claim 23, further comprising:
calculating a group key according to the group key information; and
mutually authenticating an object device to be authenticated using the calculated group key according to a secret key cryptography.

28. The device authentication method as in claim 23, wherein the requested group key information is received from the object device to be authenticated, and the pre-stored group key version is received from an authentication server.

29. The device authentication method as in claim 23, wherein the determining of the group key information determines at least one of presence and absence of the pre-stored group key version, and when the pre-stored group key version is not received, the determining of the group key information comprises:
requesting group key information to the authentication server which comprises a group key version; and
receiving the group key information from the authentication server.

30. A method for authenticating devices using broadcast encryption (BE), the method comprising:
transmitting a group key version information from at least one device for mutual authentication;
receiving the group key version information in at least one device for mutual authentication; and
determining a recent version in the group key version information.

31. The method of claim 30, wherein the determining of the recent version comprises comparing the group key version information received from at least one device with pre-stored group key version information.

32. The method of claim 31, wherein the group key version information comprises an encrypted hash value.

33. The method of claim 32, wherein the encrypted hash value is generated by generating a random number and substituting the generated random number into a hash function.

34. The method of claim 31, wherein the received group key version information comprises at least one encrypted concatenated value.

35. The method of claim 34, further comprising verifying integrity of the group key version information by decrypting at least one encrypted concatenated value.

36. The method of claim 30, wherein the group key version information comprises BE group key information.

37. The method of claim 35, wherein the group key version information comprises at least one of a group key version, an index, and the encrypted concatenated value.

38. The method of claim 32, wherein the group key information comprises at least one of a group key version, an index, an encrypted group key, and an encrypted hash key.

39. The method of claim 30, wherein the group key version information transmitted comprises a signature of an authentication server for the group key information.
